(19) United States
(12) Patent Application Publication
(10) Pub. No.: US 2006/0042083 A1
(43) Pub. Date: Mar. 2, 2006

(54) Repair of turbines on wing

(76) Inventors: Martin C. Baker, Budd Lake, NJ (US); William F. Hehmann, Greer, SC (US); Doug Puza, Simpsonville, SC (US); Srikanth Sankaranarayanan, Greer, SC (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/929,071

(22) Filed: Aug. 27, 2004

(51) Int. Cl. B23K 26/00; B23P 6/00

(52) U.S. Cl. 29/889.1; 219/121.6; 219/121.63; 219/121.64

(57) ABSTRACT

The present invention provides an apparatus for repairing turbine blades of a gas turbine engine by a laser welding operation. The method uses a miniaturized laser and related apparatus. The miniaturized laser is fed through a borescope access hole to a desired location such as a high pressure turbine blade. The laser is then powered and manipulated so as to perform the desired welding operation. Filler material may also be provided in situ to accomplish the welding procedure. The method realizes a significant cost savings to the vehicle operator in that repairs can be accomplished without the need to remove the engine or disassemble the engine.

### FIELD OF THE INVENTION

The present invention relates to an assembly and methods for repairing turbine engine components such as turbine blades while the engine is in place on a vehicle. More particularly the invention relates to a laser repair method that accesses turbine blades or other internal components of a gas turbine engine through turbine engine access holes such as boreholes. The invention also relates to miniaturized lasers and the flexible apparatus for directing lasers within an engine interior so as to undertake an in situ laser welding of gas turbine engine components.

### BACKGROUND OF THE INVENTION

Gas turbine engines have a number of complex components that require periodic inspection. It has been found quite useful to conduct these inspections, when possible, without tearing apart the engine. For example those gas turbine engines installed on aircraft are periodically inspected using a technique known as a borescope inspection. Borescope inspections typically involve the insertion of a viewing apparatus, a borescope, from the engine exterior, through an access port to some interior portion of the engine. In a typical arrangement a borescope includes a flexible wand that carries a light source and a vision means, such as a video camera or eyepiece. The wand is usually flexible and can be manipulated such that the borescope tip can be directed to a desired point. The light and vision means then allow an operator, positioned at some point remote from the engine, to view the desired point of the engine interior via the eyepiece or on a video screen. Turbine blades are one such engine component that are inspected periodically through borescopes for signs of cracking or deterioration.

The modern jet aircraft is a very high capital thing. Demurrage costs and lost revenue potential that arises when an aircraft is out of service add to that cost. Thus maintenance and repair strategies associated with aircraft, and turbine engines in general, seek methods that have a quick turn around. The goal is to return the vehicle to service as quickly as possible consistent with quality and safety demands. There is a continuing need for improved repair methods that allow quicker and faster repairs that minimize the time that any vehicle is out of service.

The gas turbine engine especially is one aircraft component that requires a high degree of periodic maintenance. Maintenance is typically a scheduled event whereas unexpected repairs may also arise on an unscheduled basis. Many of the prior art methods related to engine maintenance and repairs require removing the engine from the body of the plane. Furthermore, certain detailed engine work also requires disassembling, or partially disassembling, the engine. Over and above the cost of the repair, this kind of work is lengthy and expensive in that it requires removing the aircraft from service. It further requires the lengthy process of disassembling and then reassembling the engine. It would be desired to find an alternative repair method to those repairs that require removing an engine and/or disassembling an engine.

Laser welding repair has become an important aspect of turbine engine management. Gas turbine engines typically have large numbers of turbine blades and airfoils in compressor and turbine stages of the engine. Turbine blades in particular are frequently castings of high strength materials such as superalloys. These materials of which modern turbine blades are often fabricated are difficult to weld. Laser welding is one system suited to performing these repairs. Thus those repairs related to turbine blades, airfoils, and other superalloy engine components often require a laser welding operation.

However, the prior art methods of laser welding repair are disadvantageous for several reasons, particularly in terms of aircraft management. Heretofore, laser welding equipment has been relatively large and bulky. High energies associated with laser welding have required systems of large size to handle the energy levels. This means that in order to reach those areas of tight clearance in an engine, such as around turbine blades and airfoils, with a laser welding device, it is necessary to disassemble the engine. And that requires taking the airplane out of service for an extended time. Thus, it would be desired to develop improved laser welding techniques that do not require engine disassembly. It would further be desired to affect a laser welding operation while the engine remains substantially assembled.

Recently newer laser welding machines and apparatus have been developed. However, these devices still suffer from shortcomings and limitations. The newer laser welding machines have not had the mobility that would allow them to be moved into a repair area. Further compact laser welding machines have also suffered from a lack of sufficient power.

Hence there is a need for an improved laser welding system. There is a need for a laser welding system that allows laser welding repairs to take place without the need to remove a gas turbine engine from an aircraft. There is also a need for a mobile laser welding system that would permit the laser welding operation to be performed at the location of the engine. Further there is a need for a laser welding repair that does not require the engine to be disassembled. There is still a further need for a portable laser welding system with power sufficient to perform laser welding on superalloy materials. It is additionally desired that a laser welding repair method be simple and inexpensive. The present invention addresses one or more of these needs.

### SUMMARY OF THE INVENTION

The present invention provides a miniaturized laser apparatus and related components. The laser may be directed onto a workpiece such as a turbine blade through a fiber optic cable. The flexibility and size of the fiber optic cable allow it to be directed from the engine exterior to the interior of a gas turbine engine through inspection ports or “borescope holes”. Likewise feed apparatus such as powder feeders or wire feeders may also be directed from the engine exterior to the interior. Additionally visualization and illumination is brought to the workpiece through a mechanism such as a borescope. With this apparatus laser welding repairs can be performed without the need of either removing the gas turbine engine from the aircraft body or disassembling the gas turbine engine.

In one embodiment, and by way of example only, there is provided a method for performing laser repairs on components in the interior of a gas turbine engine without significantly disassembling the engine comprising the steps of: inserting a flexible conveyance from the exterior of the engine to the interior of the engine; remotely viewing the engine component; selecting a repair on the component; providing power through the flexible conveyance; and laser welding the component. The method may additionally include passing an inert gas through the flexible conveyance and providing a filler material to the component through the flexible conveyance. The method may further include the step of directing a viewing means and laser repair means in the same direction at the component. The step of laser welding may comprise projecting a laser on a target with a beam spot of area between about 8×10⁻⁵ cm² and about 8×10⁻³ cm² and/or projecting a laser on a target with an energy of between about 7×10⁴ Watts/cm² and about 5×10⁵ Watts/cm².

In a further embodiment, still by way of example, there is provided an apparatus for performing laser welding repairs comprising: a laser generator; a flexible conveyance; a flexible laser conveyance disposed within said flexible laser conveyance capable of directing a laser at a target in a given direction; an illumination means disposed within said flexible conveyance capable of illuminating the target in the same direction as the laser; and a visualization means disposed within said flexible conveyance capable of viewing a target in the same direction as the laser. The laser generator may comprise a ytterbium fiber laser or an erbium laser. The apparatus may also include a filler conveyance disposed within the flexible conveyance. There may also be included in the apparatus means to hold and direct the flexible laser conveyance, the flexible filler conveyance, the illumination means, and the visualization means, such as a bracket. The apparatus may also include a lens to focus the laser on a target. Other equipment such as a filler means and inert gas feeder may also be included.

In a further embodiment, still by way of example, there is provided a mobile laser welding system comprising: a transportable laser generator disposed on a vehicle; a flexible conveyance attached to said laser generator; means for projecting a laser through the flexible conveyance onto a target; an illumination means disposed within said flexible conveyance; and a visualization means disposed within said flexible conveyance. The mobile laser system permits the flexible laser conveyance to direct a laser at a target in a given direction, the illumination means is capable of illuminating the target in the same direction as the laser; and the visualization means is capable of viewing a target in the same direction as the laser.

In still a further embodiment, still by way of example, there is provided a flexible laser conveyance for use in remote laser welding comprising: an outer covering having a first end; a cap comprising material resistant to laser-related spalling and heat degradation attached (or removably fitted) to the end of the outer covering and said cap defining a plurality of passages; a flexible fiber optical cable capable of transmitting a laser disposed within the outer covering and also disposed within a passage of said cap; and a filler conveyance disposed within the outer sheathing and also disposed within a passage of the cap. It may further comprise an illumination means and a visualization means disposed within the outer covering and within the cap. The flexible laser may be configured so that the fiber optic cable directs a laser in a first direction, the filler conveyance projects a filler in a first direction, the illumination means projects light in a first direction, and the visualization means takes images from a first direction. A bracket may hold and direct in a first direction the fiber optic cable, filler conveyance, visualization means, and illumination means, and the system may include a means for manipulating the cap in a first direction.

Other independent features and advantages of the laser welding repair technique will become apparent from the following detailed description, taken in conjunction with the accompanying drawings which illustrate, by way of example, the principles of the invention.

### BRIEF DESCRIPTION OF THE DRAWINGS

FIG. 1 is a perspective view of the flexible laser system according to an embodiment of the invention.

FIG. 2 is a close up view of the flexible conveyance according to an embodiment of the invention.

FIG. 3 is a close up perspective view of the tip region of the flexible conveyance according to an embodiment of the invention.

FIG. 4 is a perspective view of a cap for use with a flexible conveyance according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

It has now been discovered that repairs and maintenance, including laser repairs, can be conducted at points in the interior of a gas turbine engine. It has been conceived to bundle the means to remotely view objects, convey laser power, and manipulate the direction of viewing and laser power by combining these means at the tip of a flexible conveyance. The flexible conveyance is sufficiently thin and miniaturized so as to allow it to pass into a gas turbine engine through preexisting inspection ports. Moreover, the flexible conveyance can inspect and effect laser repairs on turbine blades without the need to disassemble the engine. In a related embodiment, the flexible conveyance can also project grinding means within the engine compartment. It is further disclosed to combine the elements for this system on an easily transportable vehicle; in this manner the tools necessary to repair or maintain a gas turbine engine can be brought directly to the airplane (or other vehicle) where the engine is located.

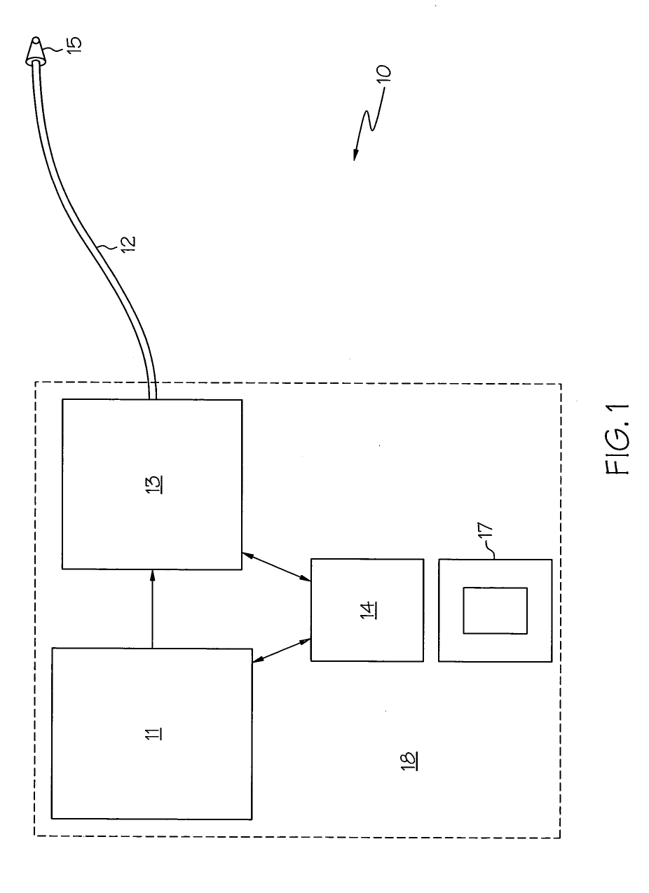

There is shown in FIG. 1 a first embodiment of the flexible laser system 10. The flexible laser system 10 comprises laser generator 11, flexible conveyance 12, controller 13, and computer 14. Alternatively the system may also comprise a monitor 17 such as a video monitor. Each of these elements is interconnected so as to allow them to cooperate with one another as further elaborated below. Controller 13, laser generator 11, computer 14, and if present monitor 17 are preferably positioned in a single location, base station 18, where an operator can interact with the controls thereof. Preferably the flexible laser system is attached to or conveyed by some mobile apparatus such as a small vehicle or hand truck. Power is supplied to laser generator 11, and other system components, by conventional means.

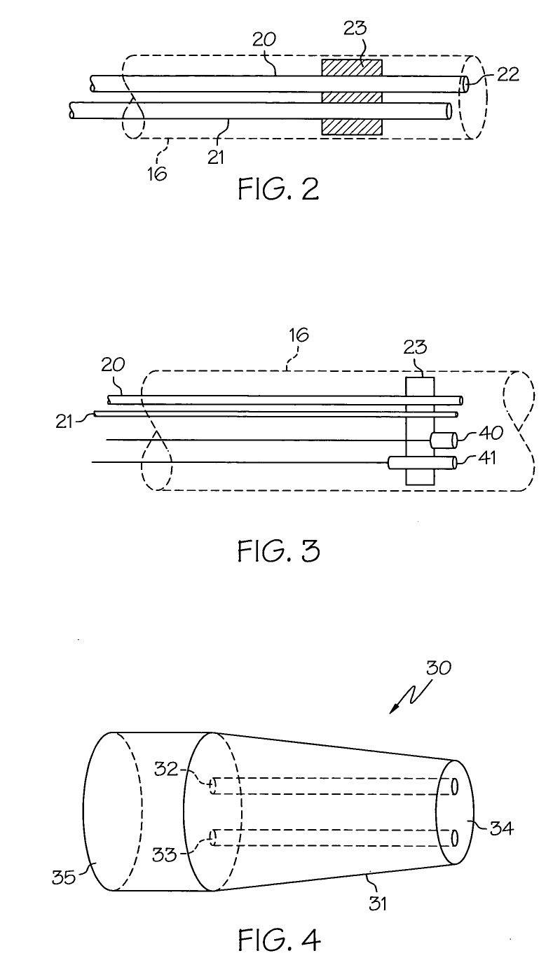

Flexible conveyance 12 is a generally flexible tube-like structure that is thin enough to fit through inspection ports of a gas turbine engine. The flexible conveyance 12 may include an outer covering 16 (shown in FIG. 2 in dashed line) or sheath such as a tube or hose. Disposed within flexible conveyance 12 are additional structures and means with which to carry out inspection and laser welding operations. This may include fiber optic conducting lines for conducting a laser. Additionally gas conveyance means and filler means may also be present. One end of flexible conveyance 12 is attached to controller 13. In a preferred embodiment, the opposite end of flexible conveyance 12 terminates at tip 15. Tip 15 is moveably connected to flexible conveyance 12 so that tip 15 can be manipulated or pointed in a desired direction.

Laser generator 11 comprises any of the known laser types including by way of example YAG lasers, diode lasers, and fiber lasers. It has been found, however, that certain kinds of lasers can be sized so as to make the laser and its conveyance suitable for the mobile and flexible laser operations. It is necessary that the laser be sufficiently compact in size so that the laser and its conveyance can be brought in proximity to a gas turbine engine. Further, the laser output that is generated must be capable of being transmitted through a flexible fiber optic cable.

Particular qualities of the desired laser include its optical beam quality and power. The beam quality of a suitable laser should be relatively high to enable the laser beam to be delivered to a target through a small diameter optical cable. Beam quality may be expressed in different terms, including the M² unit. M² is defined as the ratio of a laser's multimode beam diameter divergence product to the ideal diffraction limited (TEM₀₀) beam diameter divergence product. M² may range from 1 corresponding to an ideal diffraction limited TEM₀₀ laser beam to greater than 100 for lower quality multi-mode beams. Acceptable M² values in this application may range from 1 to 25 or as required by the specific beam delivery system characteristics. Generally a laser beam quality is sufficient when the laser beam generated therein may be conveyed through a fiber optic cable that is flexible enough to be inserted through a turbine engine inspection hole and directed at a turbine blade.

The power needed by the laser generator 11 is generally power sufficient to generate a laser beam that can affect laser welding on a gas turbine engine turbine blade. Preferably an acceptable power level is between about 10 watts to about 1 Kwatts. More preferably, laser welding in the present invention can be carried out at power levels up to about 500 watts.

Thus it has been found that the Ytterbium fiber laser is preferably suited to the present invention. In particular, the fiber laser manufactured by IPG Photonics of Massachusetts, USA is one acceptable kind of fiber laser. This preferred laser develops a laser beam with wavelength of approximately 1.08 μm (micrometers). An Erbium-based laser may also be used in the present system.

In a preferred embodiment, the laser welding system operates in a power range that varies depending on the range of areas desired for the laser beam spot. For laser beam spot areas of between approximately 8×10⁻⁵ cm² to approximately 8×10⁻³ cm² a preferred power range is between approximately 10 Watts and approximately 500 Watts. Within this range of operation, it is also preferred to control the linear velocity of the laser beam spot over the surface of the workpiece. A preferred range of linear velocity is determined by the operator based on an assessment of melt pool characteristics during the welding process. Since linear velocity is controlled manually in the preferred process, adjustments may be made as deemed necessary by the operator in order to maintain the desired weld characteristics. Typical linear velocity is between approximately 0.1 cm/second and approximately 0.5 cm/second.

Referring now to FIG. 2 there is shown a close up view of a preferred embodiment of flexible conveyance 12. In one embodiment, flexible conveyance includes laser conductor 20 and filler conveyance 21. Laser conductor 20 and filler conveyance 21 are preferably surrounded by outer covering 16. Laser conductor 20 preferably comprises a fiber optic cable. This fiber optic cable receives and conveys the laser beam generated by laser generator 11. Laser conveyance 20 includes an exit 22 where the laser beam exits laser conveyance 20. The fiber optic cable is sufficiently flexible so as to allow insertion of the device into the internal portion of a gas turbine engine and manipulation of the tip.

Filler conveyance 21 includes the structure for delivering a welding filler material to the target. Preferably, filler conveyance 21 comprises a wire feeder or a powder feeder. In one embodiment, filler conveyance 21 comprises a powder feeder. One embodiment of a powder feeder comprises a feeder that is in a coaxial arrangement with laser conveyance 20. Thus, for example, the powdered material that flows out of the powder feeder emerges in a pattern that surrounds, or partially surrounds, the laser beam as it exits laser conveyance 20 and ultimately converges with the laser beam at the workpiece melt pool. An inert gas flow may also pass through filler conveyance 21 as a means of assisting the flow of powdered material.

In a further embodiment, an additional means of inert gas flow (not shown) may also be included in the flexible laser apparatus. This additional means may comprise a separate inert gas line, separate from inert gas delivered with any feeder material, disposed within flexible conveyance 12. This inert gas line delivers inert gas through and out of flexible conveyance 12 at tip 15. The inert gas flow may be used to generally blanket the area to receive the laser welding with an inert shield, while also providing cooling to the apparatus. Alternatively, an inert gas flow may be provided through flow structure that is separate from the flexible laser apparatus.

An alternative embodiment of the flexible laser system is shown in FIG. 3. In this embodiment, flexible conveyance 12 further comprises an illumination means 40 and a visualizing means 41. Illumination means 40 and visualizing means 41 may be linked to other components such as laser conveyance 20 and filler conveyance 21. Bracket 23 may be used to join these components and to hold them in alignment.

Illumination means 40 may comprise a lamp or light source. Illumination means provides light in a selected direction. The light illuminates a target area so that the area becomes visible. Illumination means 40 preferably includes a power source connected to an electric cord. The electric cord may be fed through flexible conveyance 12. The electric cord is connected to a lamp or bulb at a terminal end. The lamp or bulb is positioned in the end of flexible conveyance. Alternatively, the light source may be located remotely and illumination transmitted to the target area by means of a flexible optical light guide.

Visualizing means 41 may comprise various embodiments and provides a means to remotely view a target area. In a preferred embodiment, visualizing means 41 comprises a video camera positioned at the tip of flexible conveyance 12. The camera embodiment can include a chip to convert video data to digital form. The video camera embodiment further includes transmission and power lines that may pass through flexible conveyance 12. Alternatively a camera may be located remotely and coupled to the tip through an image preserving fiber optic cable and lens located near the tip. When a video camera is used, a video monitor 17 is further provided. Preferably, the video monitor is positioned at a base station 18. The base station is a working station where the operator can monitor and control the flexible laser welding system. Video monitor 17 is attached to video camera, and the image captured by video camera is displayed on the monitor through interconnecting cabling. Visualizing means 41 is positioned so that it views a selected direction. When a target is positioned in the same direction as the visualizing means, the visualizing means can thus view the target.

In a further embodiment, illumination means 40 and visualizing means 41 are part of a separate assembly such as a borescope or fiberscope. Thus a device such as a borescope or fiberscope may be used in conjunction with a laser assembly according to an embodiment of the present invention, in order to provide illumination and visualization of a laser repair.

In a preferred embodiment the flexible laser system 10 further includes a manipulator. The manipulator comprises the structure that effects a movement of the flexible conveyance 12, and particularly the tip thereof. Thus the manipulator includes pulleys, wires, lines, guides, screw rods and gearing. As is known in the borescope art, manipulator comprises the structure in the base station as well as structure in the flexible conveyance itself. Thus controller 13 can effect minute movement in the flexible laser system through commands entered through the controller. U.S. Pat. No. 6,542,230 includes a description of known manipulator means and is incorporated herein by reference.

In a preferred embodiment, video camera, monitor 17, and controller 13 allow video-assisted, computer controlled laser welding. Thus, for example, the video camera can send digital information regarding the target to a computer associated with the controller. The operator can use this data to select automatic welding programs. These programs can then automatically perform welding operations on the target. In this embodiment, the manipulator can also be integrated into the video monitor and control system.

In a further embodiment, visualizing means 41 comprises an eye piece. An eye piece is disposed at the tip of flexible conveyance 12. A sight tube, such as a fiber optic cable, is connected to the eye piece and transmits an image from tip to the base station. There an operator can view the image captured by the eye piece. In one embodiment an eye piece is combined with a video imaging system in which case the eye piece provides a manual means to quickly view and direct the progress of the flexible welding system.

In one embodiment, bracket 23 is disposed so as to secure laser conveyance 20 and filler conveyance 21 in desired relative positions. Bracket 23 may thus act as a spacer in addition to a securing structure. Additionally, bracket 23 may be used to position an illumination means 40 and visualization means 41 as well as the laser welding devices. In one embodiment bracket 23 is disposed within the outer tubing that surrounds flexible conveyance 12. The tubing may comprise an integral part of the spacer or bracket. Alternatively, bracket 23 may be affixed to the components without any tubing or covering surrounding bracket.

Referring now to FIG. 4 there is shown a cap 30 for use with an embodiment of flexible conveyance 12. Laser repair operations within the close quarters of a fully assembled gas turbine engine subjects the laser delivery components such as the fiber optic cable and the feed delivery system to wear and degradation. In particular the sections of these items that are close to the laser welding, the tips or ends of the optics and the feeder, can undergo wear. The wear includes degradation, spalling, and heat fatigue. Cap 30 provides a quickly replaceable part that resists laser-related degradation and allows laser operations to quickly resume by replacement of a worn cap with a fresh one.

In a preferred embodiment, cap 30 comprises a body 31 with a front area 34 and rear area 35. Body 31 provides a housing or structure within which are disposed laser conduit 32 and feeder conduit 33. Cap 30 is preferably formed so that it can snap onto the end, tip 15, of flexible conveyance 12. In one embodiment, cap 30 engages with receiving means (not shown) on bracket 23 or on flexible conveyance 12 to hold cap 30 in place. Alternatively, other structures including reciprocal threading may be affixed to flexible conveyance 12 for securing with cap 30.

Laser conduit 32 conveys a laser beam through cap 30 and directs the laser beam out of the front area 34 of cap 30. Preferably laser conduit 32 has a coupling (not shown) which allows laser conduit 32 to link with laser conveyance 12 without significant affect on the laser beam therein. Likewise feeder conduit 33 receives a feeder material and conveys it through tip 30. Feeder conduit 33 directs a feeder material out of the front area 34 of cap 30. Preferably feeder conduit 33 also has a coupling means (not shown) allowing feeder conduit to join with feeder conveyance 21 without significantly affecting feeder passage therethrough.

A portion of the inert shield gas flow directed through conduits 32 and 33 serves to prevent smoke and debris from reaching the optical and mechanical components which are protected by the cap.

Alternatively, laser conduit 32 and feeder conduit 33 form passages within body 31 of cap 30. In this embodiment, the structure of laser conductor 20 and filler conveyance 21 pass through these passages such that, when cap 30 is affixed to flexible conveyance 12, laser conductor 20 and filler conveyance 21 terminate at the front area 34 of cap 30. Further, cap 30 can include passages and recesses wherein illumination means 40 and visualization means 41 may be positioned.

In a preferred embodiment cap 30 is molded and comprises in part ceramic material. Alternatively, cap 30 may be formed of other materials with heat resistance including ceramics, optical materials such as sapphire or fused silica, alloys, and composites. A highly reflective finish may be applied to the cap to provide further protection from reflected or scattered laser and thermal radiation.

In one embodiment, laser conduit 32 and feeder conduit 33 may be offset so that their ends do not fully extend to the rear area 35 of body 31. In this embodiment the ends of laser conduit 32 and feeder conduit 33 are drawn within body 31. Thus the coupling of cap 30 with flexible conveyance 12 extends body 31 over the point at which laser conveyance 20 meets laser conduit 32 and the point where feeder conveyance 21 meets feeder conduit 33. In one embodiment, laser conduit 32 receives the end of laser conveyance 20.

Flexible conveyance 12, and components such as laser conveyance 20, filler conveyance 21, illumination means 40 and visualization means 41, and their supporting cabling are preferably flexible. The degree of flexibility required is enough to lead the laser conveyance and filler conveyance, and other components, from a position at the engine exterior through an access port, to the engine interior so that the laser beam and filler material may be directed at a target engine component such as a turbine blade.

Laser conveyance 20 may optionally include ancillary laser guidance components. This may include for example lenses, mirrors, and guide beams. As is known in the laser art, this equipment may be used to focus and project a laser onto a chosen target with a selected spot area and intensity.

Referring again to FIG. 4 there is also shown a preferred configuration of an embodiment of the flexible laser system. In this configuration multiple components are directed in a similar direction. This is achieved by directing the tip in a given direction or toward a chosen target. This act also effects an alignment of the illumination means 40, visualization means 41, and laser welding means. There is no need to independently align a separate component such as, for example, visualizing a target and then focusing the laser on the selected target. The illumination means 40 is positioned so that it casts light in a chosen direction (or on a selected target). The viewing means 41 views in the same direction (or the same target). And the laser 20 is similarly focused or directed in the same direction (or at the same target). This common pointing of components is achieved, in one embodiment, by fixing the components in a tip 15 with a common alignment. This pointing or manipulating the tip 15 will similarly point the components attached thereto. It is noted, however, that while a movement of the tip 15 simultaneously directs each of these components, the components themselves may be separately and individually energized or activated. Thus, for example, the laser 20 may be deactivated or deenergized during a time in which the illumination means and viewing means are activated. Such a selective activation may be desired when inspecting a turbine blade prior to welding operations. Then, at a later time, the laser can be activated in order to perform a laser welding operation.

The above embodiment has described the illumination means 40, visualization means 41, and laser 20 as having a common direction. Other system components, such as for example a wire feeder or powder feeder, may be similarly aligned. In that configuration a movement of the tip 15 also moves the feeder 21. Thus, the feeder will be in alignment with the laser so as to provide material for any needed laser operation.

Also included in the laser welding system is controller 13. Controller 13 may include computer 14 and control equipment needed to operate the laser welding system in an automated or manually controlled manner. As is known in the art the controller 13 and components in cooperation may allow for automated control or manual control of the laser tip.

In an additionally preferred embodiment, multiple items of the laser apparatus are combined and disposed on a transportable device in order to provide a mobile laser system. Preferably the system components, or a significant number thereof, may be positioned on a carrier vehicle. A suitable carrier vehicle would include a hand truck, golf cart, or the like. The carrier vehicle should itself allow the mobile laser system to be brought close to a gas turbine engine, such as for example into an airplane hangar, so as to allow repairs on the target engine. The components of the mobile laser system are preferably small and compact in design. The laser generator, in particular, should be chosen for lightweight design so that it may be transported on a carrier vehicle to the gas turbine engine. In that regard, the Ytterbium fiber laser is preferred for its compact yet powerful design. An Erbium-based laser may also be used.

Having described the invention from a structural standpoint, a method and manner of using the invention will now be described.

In one embodiment, components of a mobile laser system are first brought into proximity with a gas turbine engine. If the engine is attached to a vehicle such as an airplane, the mobile laser system may be brought into the airplane hangar. Other areas that warehouse equipment with gas turbine engines, such as garages, may also be repair sites. The vehicle that carries the mobile laser system is positioned sufficiently close to the target engine so that the flexible conveyance 12 can reach into desired repair locations of the engine. The mobile laser system may carry its own power supply, or it may be attached to a power supply at the facility.

In order to perform a laser welding repair according to one embodiment, an inspection port of a gas turbine engine is first opened. The flexible conveyance 12 is then inserted into the port and directed toward a desired position such as a stage of turbine blades. In a preferred embodiment, a borescope inspection is combined with laser welding steps. In this embodiment, the turbine blades are first visually inspected. Using techniques known in the industry, the illumination means 40 and visualizing means 41 are used to project images of a target item to a monitor 17. An operator can view images of the target through monitor 17 positioned at base station 18. A human operator there determines whether a particular target is in need of repair.

When it is determined that an item is in need of repair, a laser welding step then takes place. In the case of a turbine blade with a crack that is susceptible to laser welding repair, the flexible conveyance 12 is first positioned at a point proximate to one end of a cracked region. The laser generator 11 is activated thus generating a laser beam. The laser beam is directed through the laser conveyance 20 onto the target. At a desired time, typically simultaneously with the projection of the laser beam, filler conveyance 21 directs a filler material proximate to the surface of the target being repaired. The manipulator, either under automated or manual control, traverses the tip 15 of flexible conveyance 12 across the area to be laser welded. Manual control is a preferred method. As is known in the art, laser welding may require multiple passes to build up a layer or material with a desired thickness and/or welding passes in a stitching pattern to cover a desired area.

Subsequently, post welding inspection and finishing may be required via established borescope blending techniques.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for performing laser repairs on components in the interior of a gas turbine engine without significantly disassembling the engine comprising the steps of:
inserting a flexible conveyance from the exterior of the engine to the interior of the engine;
remotely viewing the engine component;
selecting a repair on the component;
providing power through the flexible conveyance; and
laser welding the component.

2. The method according to claim 1 further comprising the step of passing an inert gas through the flexible conveyance.

3. The method according to claim 1 further comprising the step of providing a filler material to the component through the flexible conveyance.

4. The method according to claim 1 further comprising the step of directing a viewing means and laser repair mains in the same direction at the component.

5. The method according to claim 1 further comprising the step of transporting a mobile laser system and remote viewing system adjacent to the gas turbine engine.

6. The method according to claim 1 wherein the step of laser welding further comprises laser welding with an Ytterbium fiber laser.

7. The method according to claim 1 wherein the step of laser welding further comprises laser welding with an Erbium fiber laser.

8. The method according to claim 1 wherein the step of laser welding further comprises projecting a laser on a target with a beam spot of area between about 8×10⁻⁵ cm² and about 8×10⁻³ cm².

9. An apparatus for performing laser welding repairs comprising:
a laser generator;
a flexible conveyance;
a flexible laser conveyance disposed within said flexible conveyance capable of directing a laser at a target in a given direction;
an illumination means disposed within said flexible conveyance capable of illuminating the target in the same direction as the laser; and
a visualization means disposed within said flexible conveyance capable of viewing a target in the same direction as the laser.

10. The apparatus according to claim 9 wherein said laser generator further comprises an Ytterbium fiber laser.

11. The apparatus according to claim 9 wherein said laser generator further comprises an Erbium fiber laser.

12. The apparatus according to claim 9 further comprising a filler conveyance disposed within said flexible conveyance.

13. The apparatus according to claim 9 further comprising means to hold and direct the flexible laser conveyance, the flexible filler conveyance, the illumination means, and the visualization means.

14. The apparatus according to claim 13 wherein the means to hold and direct comprises a bracket.

15. The apparatus according to claim 9 further comprising a lens to focus the laser on a target.

16. The apparatus according to claim 9 further comprising a filler means.

17. The apparatus according to claim 9 further comprising an inert gas feeder.

18. A mobile laser welding system comprising:
a transportable laser generator disposed on a vehicle;
a flexible conveyance attached to said laser generator;
means for projecting a laser through the flexible conveyance onto a target;
an illumination means disposed within said flexible conveyance; and
a visualization means disposed within said flexible conveyance.

19. The mobile laser system according to claim 18 wherein said laser generator comprises an Ytterbium fiber laser.

20. The mobile laser system according to claim 18 wherein said laser generator comprises an Erbium fiber laser.

21. The mobile laser system according to claim 18 wherein said laser generator can provide a laser energy of between about 10 W and about 1000 W.

22. The mobile laser system according to claim 18 wherein said means for projecting a laser comprises flexible fiber optic cable.

23. The mobile laser system according to claim 18 wherein said laser generator and said means for projecting a laser can project a laser on a target with a spot area of between about 8×10⁻⁵ cm² and about 8×10⁻³ cm.

24. The mobile laser system according to claim 18 wherein said flexible laser conveyance disposed is capable of directing a laser at a target in a given direction; said illumination means is capable of illuminating the target in the same direction as the laser; and said visualization means is capable of viewing a target in the same direction as the laser.

25. A flexible laser conveyance for use in remote laser welding comprising:
an outer covering having a first end;
a cap comprising material resistant to laser-related spalling and heat degradation attached to the end of the outer covering and said cap defining a plurality of passages;
a flexible fiber optical cable capable of transmitting a laser disposed within the outer covering and also disposed within a passage of said cap; and
a filler conveyance disposed within said outer sheathing and also disposed within a passage of said cap.

26. The flexible laser conveyance according to claim 25 further comprising an illumination means and a visualization means disposed within said outer covering and within said cap.

27. The flexible laser conveyance according to claim 25 wherein said fiber optic cable directs a laser in a first direction, said filler conveyance projects a filler in a first direction, said illumination means projects light in a first direction, and said visualization means takes images from a first direction.

28. The flexible laser conveyance according to claim 25 wherein said cap is removably fitted to said outer covering.

29. The flexible laser conveyance according to claim 25 further comprising a bracket for holding and directing in a first direction said fiber optic cable, filler conveyance, visualization means, and illumination means.

30. The flexible laser conveyance according to claim 29 further comprising a means for manipulating the cap in a first direction.
